(19) United States
(12) Patent Application Publication
(10) Pub. No.: US 2009/0032694 A1
(43) Pub. Date: Feb. 5, 2009

(54) Radon test kit

(76) Inventor: Garrett A. Ray, Mt. Ephraim, NJ (US)

Correspondence Address: NORMAN E. LEHRER, P.C., 1205 NORTH KINGS HIGHWAY, CHERRY HILL, NJ, 08034, US

(21) Appl. No.: 11/888,635

(22) Filed: Aug. 1, 2007

(51) Int. Cl. G01T 7/00; G01T 1/00

(52) U.S. Cl. 250/255

(57) ABSTRACT

A radon test kit includes a housing, a plurality of canisters stored within the housing, a quantity of activated charcoal stored within each of the canisters, a gauge for measuring and indicating humidity mounted within the housing, and a sensor for measuring and indicating ambient temperature mounted within the housing. The ambient temperature sensor also includes indicia to show the temperature. The humidity gauge also includes indicia to indicate the moisture level. The temperature sensor and the humidity gauge measure the temperature and moisture level, respectively, of the test area during the test period so that an accurate calculation of the concentration of radon gas being emitted in the test area may be made.

### BACKGROUND OF THE INVENTION

The present invention is directed toward a radon test kit and more particularly, toward a test kit that measures and indicates the humidity level and ambient temperature of a test area during the test period.

The sampling and measuring of ground radon emission have become important practices, especially when purchasing real estate. This is so because the infiltration of radon gas into any structure where people reside or work may reach dangerous levels and become a health risk. Prolonged exposure to radon gas may lead to lung cancer.

The most common way to measure the amount of radon gas being emitted in a certain area is the use of activated charcoal. The charcoal, in a container, is exposed to the air inside a structure, such as a home. The charcoal is left in place for a predetermined amount of time. The charcoal adsorbs radon gas. After the time period is over, the charcoal is removed and the charcoal is analyzed in order to determine the amount of radon gas that has been adsorbed by the charcoal. The concentration of radon gas in the test area can then be calculated. This is frequently done by a home owner utilizing a kit purchased from a testing lab. After the home owner leaves the container with the charcoal therein open for the required period of time, the container is mailed or otherwise delivered to the testing lab for analysis.

While the use of activated charcoal is a popular method for detecting the amount of radon gas being emitted in a certain area, there are several factors that may lead to inaccurate results. For example, the activated charcoal responds slowly to changes in ambient radon gas levels and must be left in place for several days in order to obtain an accurate reading. Also, actual levels of radon gas in the air vary throughout the day and the ultimate test result may merely be an average. However, the more significant factors that must be taken into consideration when using activated charcoal for detecting radon gas levels is the amount of moisture in the air as well as the temperature.

Humidity plays a large role when calculating the level of radon in a test area. Because the activated charcoal adsorbs moisture as well as radon gas, the amount of radon gas that can be adsorbed will be affected by the amount of moisture that is adsorbed by the charcoal. Therefore, it is important to know how much moisture is being adsorbed so that this may be factored into the calculation.

Attempts have been made to more accurately assess the amount of radon gas being emitted in a test area. For example, U.S. Pat. No. 4,920,263 to Fimian et al. discloses a radon detection system that monitors certain environmental parameters, such as humidity, barometric pressure, and temperature. This system, however, appears to be rather complicated and not easily set up and carried out by the average person.

Therefore, a need exists for a radon test kit that is easy to use and that accurately measures and records the humidity level and temperature in a test area during a testing period.

### SUMMARY OF THE INVENTION

The present invention is designed to overcome the deficiencies of the prior art discussed above. It is an object of the present invention to provide a radon test kit that accurately measures and indicates the humidity and ambient temperature during a testing period.

It is another object of the present invention to provide a self-contained radon test kit that is easy and convenient to use.

In accordance with the illustrative embodiments demonstrating features and advantages of the present invention, there is provided a radon test kit that includes a housing, a plurality of canisters stored within the housing, a quantity of activated charcoal stored within each of the canisters, means for measuring and indicating humidity mounted within the housing, and means for measuring and indicating ambient temperature mounted within the housing. The ambient temperature measuring and indicating means includes a sensor sensitive to temperature and includes indicia to show the temperature. The humidity measuring and indicating means includes a gauge sensitive to moisture found in the air. The gauge also includes indicia to indicate the moisture level.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form that is presently preferred; it being understood that the invention is not intended to be limited to the precise arrangements and instrumentalities shown.

FIG. 1 is a front perspective view of the radon test kit of the present invention with the cover opened;

FIG. 2 is a view of the radon test kit of the present invention similar to Figure but showing the same in use and with portions broken away for clarity;

FIG. 3 illustrates the humidity and temperature indicators included in the test kit of the present invention;

FIG. 4 is an exploded view of one of the canisters included in the test kit of the present invention; and

FIG. 5 is a partial cross-sectional view of the activated charcoal contained in the test kit of the present invention.

### DETAILED DESCRIPTION OF THE PREFERRED EMBODIMENT

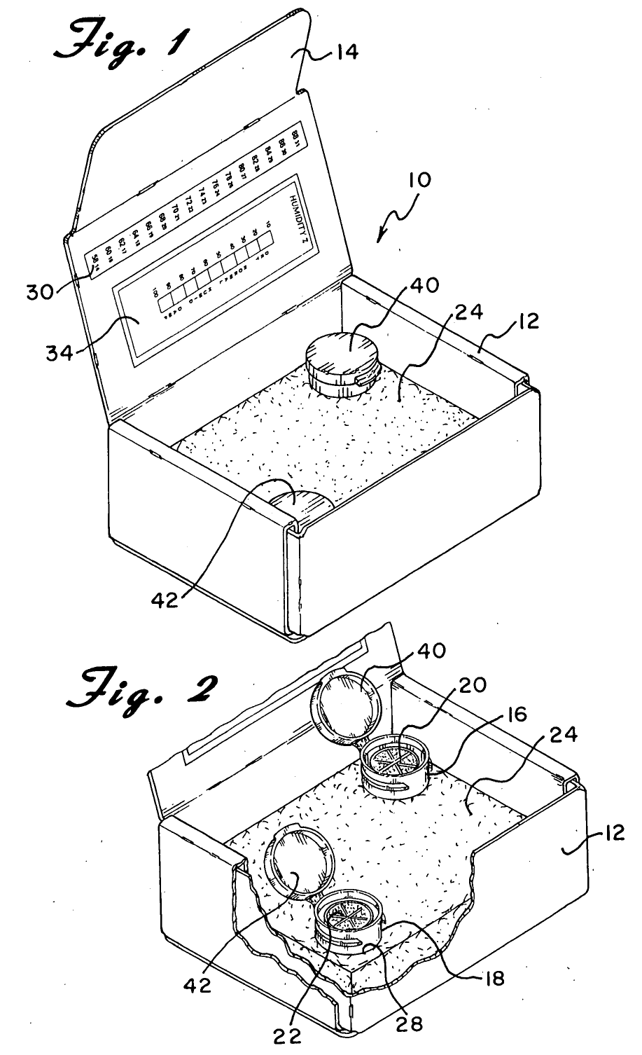

Referring now to the drawings in detail wherein like reference numerals have been used throughout the various figures to designate like elements, there is shown in FIG. 1 a radon test kit constructed in accordance with the principles of the present invention and designated generally as 10.

The radon test kit of the present invention essentially includes a housing 12 generally in the shape of a square box with a cover or lid 14, a plurality of canisters or vials 16 and 18 stored within the housing 12, a quantity of activated charcoal 20 and 22 stored within each of the canisters 16 and 18, respectively, means for measuring and indicating humidity mounted within the housing, and means for measuring and indicating ambient temperature mounted within the housing.

The housing 12 need not be more than a cardboard box. The box can be used as a mailer for mailing the entire kit to a consumer. After use, the box can be used to mail the kit back to the laboratory for analysis. In the preferred embodiment of the invention, the box or housing 12 is approximately five and a half inches wide, four inches deep and two inches high. This provides sufficient space within the box to allow the canisters 16 and 18 to be at least four inches away from each other.

Located within the housing 12 is a pad 24 with some thickness that may be made from urethane foam or a similar material. The pad 24 may include two openings 26 and 28 in which the respective canisters 16 and 18 sit securely and cushion the canisters 16 and 18 therein. (See FIGS. 2 and 4.) The openings 26 and 28 are located at opposite ends of the housing 12 at least four inches apart from each other. (See FIG. 2.)

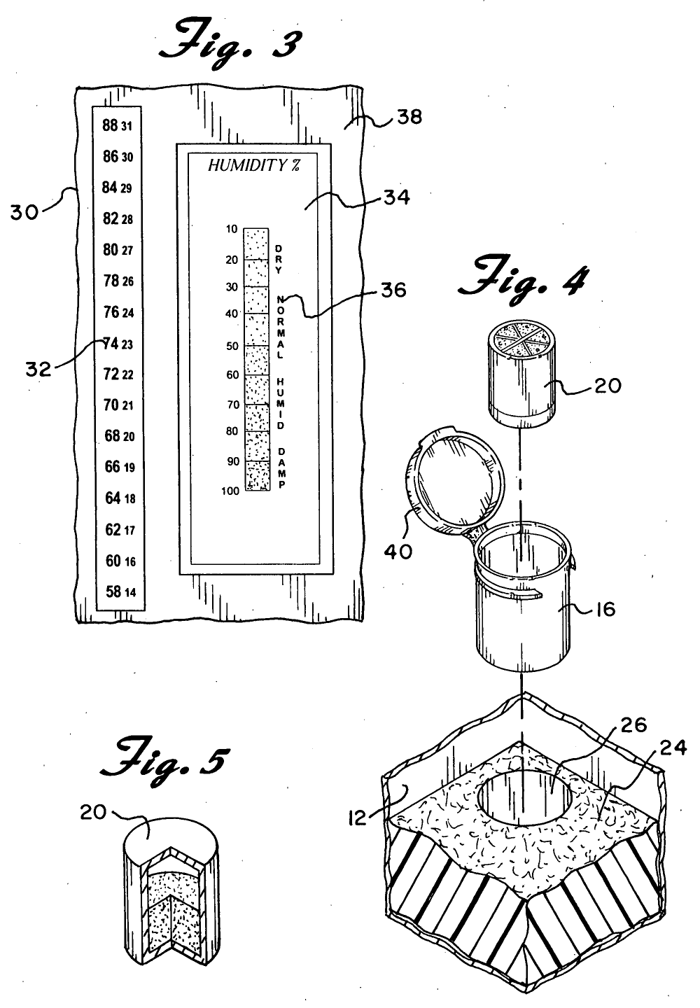

The ambient temperature measuring and indicating means includes a sensor 30 sensitive to temperature and includes indicia 32 to show the temperature. (See FIG. 3.) The sensor 30 is, essentially, a thermometer. The humidity measuring and indicating means includes a gauge 34 sensitive to moisture found in the air. The gauge 34 also includes indicia 36 to indicate the moisture level. (See FIG. 3.) The temperature measuring means and the humidity measuring means are mounted on the inner side 38 of the housing cover 14 of the housing. (See FIG. 1.)

In order to use the present invention, the kit is placed in a test area. The cover 14 of the housing 12 is then opened and the caps 40 and 42 of the canisters 16 and 18, respectively, are opened to allow the carbon to absorb the radon gas. The canisters 16 and 18 need not be removed from the housing 12. The kit must be left undisturbed for 48-96 hours. After this time period, the caps of the canister are closed. The temperature and humidity levels are read from the respective measuring means and recorded and the recorded information is left in the housing 12. The cover of the kit is closed and the entire kit sent is sent to a laboratory to be analyzed. During the analysis by the lab, the humidity can be factored into the analysis.

The present invention may be embodied in other specific forms without departing from the spirit or essential attributes thereof and accordingly, reference should be made to the appended claims rather than to the foregoing specification as indicating the scope of the invention.

I claim:

1. A radon test kit comprising:
a housing;
a plurality of canisters stored within said housing;
a quantity of activated charcoal stored within each of said canisters; and
means for measuring and indicating the humidity in the test area mounted within said housing.

2. The radon test kit of claim 1 further including means for measuring and indicating ambient temperature mounted within said housing.

3. The radon test kit of claim 2 wherein said ambient temperature measuring and indicating means includes a sensor sensitive to temperature and includes indicia to show the temperature.

4. The radon test kit of claim 1 wherein said humidity measuring and indicating means includes a gauge sensitive to moisture found in the air, said gauge also includes indicia to indicate the moisture level.
